(19) United States
(12) Patent Application Publication
(10) Pub. No.: US 2020/0281244 A1
(43) Pub. Date: Sep. 10, 2020

(54) FOOD PRODUCTS THAT CONTAIN LOW FAT, CONCENTRATED HEMP PROTEIN, AND RELATED METHODS

(71) Applicant: Manitoba Harvest USA, LLC, Minneapolis, MN (US)

(72) Inventors: Jeffrey L. Casper, Arden Hills, MN (US); Peeyush Maheshwari, Plymouth, MN (US)

(21) Appl. No.: 16/811,287

(22) Filed: Mar. 6, 2020

Related U.S. Application Data
(60) Provisional application No. 62/814,427, filed on Mar. 6, 2019.

(51) Int. Cl. A23L 33/185; A23L 11/00; A23L 19/10; A23L 19/00; A23P 30/20; A23P 30/30

(52) U.S. Cl. CPC A23L 33/185; A23L 11/05; A23L 19/11; A23V 2002/00; A23P 30/20; A23P 30/30; A23L 19/09

(57) ABSTRACT

Described are food compositions including doughs, extrudates, and finished puffed food compositions derived therefrom. The food compositions contain hemp protein, non-hemp protein, and starch. Such a food composition contains at least 40 weight percent total protein and less than 10 weight percent total fat, based on total weight of the food composition on a dry basis. Advantageously, the finished food product has a surprisingly crunchy texture. Additionally, the finished food product has improved storage stability as compared to compositions having greater levels of hemp fat.

### CROSS-REFERENCE TO RELATED APPLICATIONS

This application claims priority to U.S. Provisional Application No. 62/814,427, filed Mar. 6, 2019, the entire contents of which is incorporated herein by reference.

### FIELD OF THE INVENTION

This disclosure relates to food products that contain hemp protein, non-hemp protein, fat, and starch, and that have a relatively low fat content and a relatively high protein content, including puffed or extruded food products.

### BACKGROUND OF THE INVENTION

Ready-to-eat food products are popular among consumers because of their convenience, flavor, texture, ease of preparation (if any) and storage stability. Ready-to-eat food products include dry cereals and snack foods that are packaged and sold to consumers and can be served when desired by the consumer by opening a package that contains the food and removing the food from the container with little or no preparation. The packaged food product is relatively dry and will maintain freshness for an extended shelf-life, especially before the package is opened.

One type of ready-to-eat food product is a “puffed” food product (e.g., extruded food products) such as puffed dry cereals, and puffed snacks. This includes Cheerios®, Kix®, Cheetos®, and other corn-puff snack foods. A puffed food product may also be included as an ingredient, with other ingredients, in forming a finished food product, such as a snack bar, cracker, cookie, or the like.

Puffed food products are typically produced by extrusion or other expansion techniques. The formulation of the food product (i.e., its ingredients) and the processing technique and conditions will determine the textural characteristics of being crispy or crunchy, tough or tender, hard or soft, or of a relatively higher or lower density.

Puffed food products can be made using various known ingredients that contain a combination of protein, starch, fat, and optional minor ingredients.

### SUMMARY OF THE INVENTION

Hemp protein is a food material that can be prepared to be generally regarded as safe (GRAS) for use in foods for humans. Research has been performed to identify ways to include hemp protein in food products. See, e.g., US patent publication 2007/0149307, US patent publication 2012/0288588, and Chinese patent publication 1561829 (“Hemp seed protein powder and its preparing method and use.”) Despite these efforts, the use of hemp protein has not yet become very widespread.

As described herein, the Applicant has now discovered that certain types of food compositions prepared to include an amount of hemp protein (along with other ingredients as described hereinbelow) can be useful or advantageous for preparing puffed food compositions, particularly in puffed food compositions that contain a relatively low amount of fat and a relatively high amount of protein.

In particular examples, the Applicant has discovered that a low fat, high protein puffed food composition can be prepared that includes a combination of non-hemp protein and hemp protein, and that the resultant puffed food composition exhibits desirable food properties such as flavor and texture. This is particularly true when the hemp protein ingredient has low-fat content. This is important because the fat contributions from hemp are high in unsaturated fatty acids, which are prone to oxidation during the extrusion process.

Example puffed food products can have a density that is relatively low, and that may be lower than a density of a comparable puffed food product made with the same amounts and types of ingredients, including the same amount of total protein, but with no hemp protein. As used in this paragraph (and elsewhere in this disclosure, unless specifically stated otherwise), the term “amount” refers to weight percentages of ingredients or components of the food composition measured on a dry basis.

Compared differently, a density of an inventive puffed food composition that is made using a hemp protein ingredient (as described herein) can be lower than a density of a comparable puffed food composition that is the same but is made without the hemp protein ingredient. The inventive puffed food composition made from ingredients that include starch, hemp protein ingredient, and non-hemp protein and non-hemp fat (e.g., from a non-hemp protein ingredient), can have a density that is below 90 percent of, e.g., below 80 percent, below 70 percent, below 60 percent, or even at or below 50 percent of, a density of a comparable puffed food composition made from the same total amounts of starch, protein, and fat, but not containing the hemp protein ingredient.

In one aspect, the present disclosure relates to a food composition that includes starch and at least 40 weight percent protein based on total weight of the food composition on a dry basis. The protein includes both hemp protein and non-hemp protein. The non-hemp protein can be or comprise at least one of soy protein, pea protein, rice protein, legume protein, sacha inchi protein, algal protein, and mycoprotein (including any combinations thereof). The food composition may also contain fat, such as a combination of hemp fat and non-hemp fat, at a level of below 10 weight percent total fat, based on total weight of the food composition on a dry basis. In certain embodiments, the food composition includes from 5 to 40 weight percent starch, from 40 to 80 weight percent total protein, and from 1 to 5 weight percent total fat, based on the total weight of the food composition on a dry basis. In some cases, the food composition contains less than 1 weight percent total gluten based on total weight of the food composition on a dry basis.

In some embodiments, the food composition is a puffed food composition. In such embodiments, the puffed food composition can have a water content below 5 weight percent based on the total weight of the food composition. In certain embodiments, the food composition is an extruded food composition having a density that is lower than a density of a comparable food composition, wherein the comparable food composition is devoid of hemp protein but has the same weight percentage of total protein as the food composition of the present disclosure. For example, the food composition of the present disclosure may be an extruded food composition having a density that is below 0.3 grams per cubic centimeter (g/cc). In certain embodiments of this nature, the food composition is an extruded food composition having a density that is below 0.25 grams per cubic centimeter.

In certain embodiments, the hemp protein is part of a hemp protein ingredient. In such cases, the hemp protein ingredient can include at least 70 weight percent hemp protein and not more than 10 weight percent hemp fat, based on total weight of the hemp protein ingredient on a dry basis. In certain embodiments, the hemp protein ingredient can include from 60 to 95 weight percent hemp protein, less than 6 weight percent fat, and less than 10 weight percent water, based on total weight of the hemp protein ingredient on a dry basis.

In some embodiments, the food composition includes from 0 to 7 weight percent non-hemp fat, and from 0.1 to 5 weight percent hemp fat, based on the total weight of the food composition on a dry basis. In any embodiment of the present disclosure, the non-hemp protein can be part of a non-hemp protein ingredient. Such a non-hemp protein ingredient can include at least 60 weight percent non-hemp protein and not more than 10 weight percent non-hemp fat, based on total weight of the non-hemp protein ingredient on a dry basis.

In another aspect, this disclosure provides a method of preparing an expanded food composition. The method includes: combining ingredients to prepare a dough that includes starch, at least 40 weight percent protein on a dry basis, with the protein comprising both hemp protein and non-hemp protein. The non-hemp protein can be or include pea protein, rice protein, or legume protein. The food composition may also contain fat at a level below 10 weight percent total fat based on total weight of the dough on a dry basis.

In certain embodiments of the method, the hemp protein is part of a hemp protein ingredient. In embodiments of this nature, the hemp protein ingredient can include at least 70 weight percent hemp protein and not more than 10 weight percent hemp fat, based on total weight of the hemp protein ingredient on a dry basis. In some embodiments, the hemp protein ingredient can include from 60 to 95 weight percent hemp protein, less than 6 weight percent fat, and less than 10 weight percent water, based on total weight of the hemp protein ingredient on a dry basis.

The method further includes extruding the dough to form an expanded food composition. In some embodiments, the expanded food composition has a density that is below 0.3 grams per cubic centimeter.

The method can also include drying the expanded food composition. In some cases, after drying, the expanded food composition has a water content below 5 weight percent based on total weight of the expanded food composition.

### DETAILED DESCRIPTION

The following description relates to food compositions that include hemp protein and non-hemp protein, and that contain a relatively high amount of total protein and a relatively low amount of total fat, as well as related processing methods.

The present disclosure provides a food composition that includes hemp protein, non-hemp protein, and starch, with a relatively low amount of total fat and a relatively high amount of total protein in the food composition.

As described herein, the Applicant has discovered that hemp protein, for example as part of a low fat concentrated hemp protein ingredient, can be used in combination with non-hemp protein and starch to produce an expanded, “puffed” (i.e., low density) food product that has useful and/or desirable organoleptic (e.g., taste and texture) properties. The puffed food composition can be prepared from a dough that contains the hemp protein, non-hemp protein, starch, and a useful amount of water, by causing the dough to expand upon passing through an extruder. The extruded dough composition can be dried to produce a finished extruded, “puffed,” low density food composition that has useful and/or highly desirable properties such as a low density, good or advantageous storage stability, and desirable food properties such as one or more of taste, crunch, and nutritional properties.

As discovered by the Applicant, hemp protein can be effective as a portion of an amount of total protein in a puffed food composition by providing properties that balance or complement properties of one or more other non-hemp proteins. The one or more other non-hemp proteins may be present in the food composition in a greater total amount than the hemp protein. A non-hemp protein may be present to provide desired food properties such as nutritional properties. But a non-hemp protein may exhibit reduced, less than useful, or less than desirable functional properties such as a reduced ability to be expanded during extrusion to form a low density puffed food composition. Hemp protein may be included in combination with the non-hemp protein to produce a food composition that exhibits useful, improved, or advantageous mechanical properties, such as an increased ability to expand during extrusion to form a puffed food composition that has a lower density than a density of a comparable puffed food composition made with the same amount of total protein but which protein is entirely non-hemp protein.

Thus, the hemp protein improves the ability of the food composition to be expanded into a low density puffed food product.

Compared to other extruded food products made from comparable ingredients but without any hemp protein (e.g., made using the same amount of protein but made using entirely non-hemp protein, such as pea protein), a puffed food product of the present disclosure may exhibit desired or improved sensory or texture properties such as reduced glassiness and reduced granularity during mastication, i.e., a texture that is less coarse or “mealy” compared to a puffed food product made with the same total amount of protein but with all protein being pea protein. Additionally, the flavor profile of an inventive puffed food composition that contains a combination of hemp protein and pea protein may be more cereal-like and free from a beany or pea-like off notes typical of food products that contain the same total amount of protein but with all protein being pea protein.

The described food compositions include a “dough” composition that contains an amount of water to allow the food composition to be processed to form a low density puffed food product, such as by extrusion of the dough followed by drying. The food composition can also exist in the form of an extrudate, which is a product of extruding the dough composition. The composition also may exist in the form of a puffed, extruded (finished, dried) food composition, which is produced by extruding and drying the dough composition.

Primary food materials of example food compositions include starch, protein, fat, and water. The total amount of protein includes a portion that is derived from hemp (i.e., “hemp protein”) and a portion that is derived from a non-hemp source (i.e., “non-hemp protein”). The total amount of fat may include fat derived from hemp (i.e., “hemp fat”), fat derived from a non-hemp source (i.e., “non-hemp fat”), or a combination of these. The amount of starch can generally be any amount that will allow for the ingredients of the dough to be combined and processed to form a puffed food composition. The amount of water will vary depending on whether the composition is a dough, an extrudate, or a finished (dried) food product.

The food composition contains a relatively low amount of total fat and a relatively high amount of total protein. Examples of useful amounts of total protein (from any source) can be at least 40 weight percent, e.g., an amount in a range from 40 to 80 weight percent total protein, e.g., from about 45 to about 75 weight percent total protein in a food composition, based on total solids of the food composition on a dry basis.

The food composition can contain a combination of hemp protein and non-hemp protein. Without limiting the general description of the present disclosure, examples of useful amounts of hemp protein can be in a range from 10 to 50 weight percent, e.g., from 15 to 40 weight percent hemp protein, based on total protein in the food composition, on a dry basis. Examples of useful amounts of non-hemp protein can be in a range from 50 to 90 weight percent, e.g., from 60 to 85 weight percent, based on total protein in the food composition on a dry basis.

Hemp protein (also referred to herein as hemp seed protein) is protein derived from hemp seed and is understood to include two main types of proteins: edestin (also called globulin) and albumin, with globulin being present in a larger amount than albumin. Edestin is a legumin protein, and is also a globular protein that is understood to have a molecular weight of over 50,000. The relative amounts of the globulin and albumin in hemp seed protein are generally considered to be about 60 to 80 percent by weight edestin and the remainder (20 to 40 percent by weight) albumin, based on total weight protein on a dry basis.

The non-hemp protein can be any non-hemp protein that is useful in a food composition as described. The non-hemp protein may be derived from any animal, plant, or other protein source, such as from dairy (e.g., whey), soy, wheat, rice, fish, eggs, poultry, legume, or from another grain, vegetable, plant, algae, fungus, or animal source.

Sources of non-hemp protein that may at present be particularly useful in a food composition as described include plant sources that provide protein of a type that is desired as a nutritional protein in a puffed food composition, but that exhibits certain properties that are less than adequate or that may be desirably improved or augmented for use in the puffed food composition. For example, certain types of proteins that are presently desired for nutritional properties include rice protein, bean (legume) protein, and pea protein. But these types of protein are not especially suited for expanded food compositions because they do not exhibit particularly good expansion properties when extruded. Expanded food compositions made of total protein that includes only pea protein, for example, may be effective to produce a puffed food composition that has a limited range of density, e.g., a density that is not below about 0.40 or 0.35 grams per cubic centimeter. The Applicant has discovered that replacing a portion of this type of protein with hemp protein can allow for a puffed food product that has a lower density than a density of the puffed food composition made using the pea protein alone, e.g., a density that is below 0.35, below 0.3, below 0.25 or even at or below 0.2 grams per cubic centimeter.

The food product will normally contain some amount of fat, generally at least because a concentrated protein ingredient such as a hemp protein ingredient or a non-hemp protein ingredient will normally or necessarily contain at least a small percentage of fat. A protein source normally contains at least a minor amount of fat (e.g., oil), and processes for isolating the protein typically result in at least a small amount of the fat (oil) being retained in the concentrated protein isolate. The amount of fat in a typical protein ingredient may be as much as 15 or 16 weight percent, depending on the type of protein source and the type of protein isolation process.

Examples of useful amounts of total fat (from any source) in a food composition as described can be below 10 weight percent, e.g., below 7 or 8 weight percent, in a range from 0.5 to 5 weight percent total fat, or from 1 to about 4 weight percent total fat, based on total solids of the food composition on a dry basis.

In example food compositions, the amount of total fat may include fat that is derived from hemp, fat that is derived from a non-hemp source, or a combination of two or more different types of fat. This will normally occur, for example, by using ingredients that include both a hemp protein ingredient (“concentrate”) and non-hemp protein ingredient (“concentrate”). The hemp protein ingredient will normally include a small amount of hemp fat, and the non-hemp protein concentrate will normally include an amount of non-hemp fat. By using protein ingredients that include hemp fat and non-hemp fat, an amount of both types of fat will normally be present in the food composition.

Examples of useful amounts of hemp fat can be in a range from 0.1 to 6 weight percent, e.g., from 0.5 to 5 weight percent hemp fat based on total solids of the food composition on a dry basis. Examples of useful amounts of non-hemp fat can be in a range from 0 to 7 weight percent, e.g., from 0.5 to 5 or 6 weight percent non-hemp fat based on total solids of the food composition on a dry basis.

The food composition also contains an amount of starch. Starch can be derived from any starch source, such as a plant, e.g., grain, legumes, fruit, or vegetables. Examples of starch sources include wheat, corn, potato, rice, tapioca, oat, barley, millet, bananas, sorghum, sweet potatoes, rye, as well as other cereals, legumes, and vegetables. Examples of useful amounts of starch (from any source) in a dough composition as described can be in a range from about 5 to about 40 weight percent, or from about 10 to about 35 weight percent total starch in a food composition, based on total solids of the food composition on a dry basis.

A food composition can contain an amount of water that depends on the type of food composition, which in turn relates to a stage of processing of the food composition. A food composition can be in the form of a dough, in which form the food composition contains an amount of water that allows the food composition to be processed by an extrusion technique to form an extrudate. Example doughs can contain from 10 to 30 weight percent water based on total weight of the dough.

A food composition can be prepared by combining any of various food ingredients that contain one or more food material such as starch, hemp protein, non-hemp protein, hemp fat, non-hemp fat, and an amount of water, to form a dough. Example food compositions may be prepared in the form of a dough by combining a starch ingredient, a hemp protein concentrate (which contains hemp protein and a small amount of hemp fat), a non-hemp protein concentrate (which contains non-hemp protein and non-hemp fat), and other optional ingredients such as added fat, flour, or other minor ingredients or additives, with water. The dough can be extruded and processed to form a puffed food composition as described, containing desired amounts of starch, hemp protein, non-hemp protein, fat, and other optional minor ingredients as described herein.

As used herein, the term “ingredient” refers to a composition that contains one or a combination of food materials (e.g., protein, starch, fat, sugar, etc.), and that is combined with one or more other ingredients and water to form a dough as described herein that can be then processed by expansion to form a finished puffed food product. The ingredient may be characterized by the major type of food material that is contained in the ingredient (e.g., fat, protein, starch, etc.), as well as the type of the source of the material (e.g., hemp, pea, vegetable, non-hemp, grain, etc.). An ingredient can be a composition that contains a concentrated or isolated amount of a specific type of food material such as protein, and such types of ingredients may sometimes be referred to as “concentrates.”

As examples, the term “starch ingredient” refers to a composition that contains a concentrated amount of starch. The term “protein ingredient” or “protein concentrate” refers to a composition that contains a concentrated amount of protein. The term “hemp protein concentrate” refers to a composition (“ingredient”) that contains a concentrated amount of protein derived from hemp, e.g., the majority of the protein in the concentrate or entirely or substantially all of the protein in the concentrate is derived from hemp. A “non-hemp protein concentrate” refers to an ingredient that contains a concentrated amount of protein, wherein none or not more than an insignificant amount (e.g., less than 5, 1, or 0.5 percent by weight) of the protein is derived from hemp, and entirely all or substantially all of the protein in the concentrate is derived from a non-hemp source.

Consistent therewith, the more general terms “starch,” “fat,” “protein,” “sugar,” and the like (as opposed to a term that includes the word “concentrate” or “ingredient,” are used to refer to these chemically defined food materials as part of an ingredient or as part of a dough or food composition regardless of the source of the food material. A term such as “starch,” “fat,” or “protein” may also be used with an additional indication of the origin of the food material, e.g.: “hemp protein” refers to protein that is derived from hemp; “hemp fat” refers to fat that is derived from hemp; “non-hemp protein” refers to protein that is derived from a source that is different from hemp (e.g., from a pea, a rice, or a bean); and “non-hemp fat” refers to fat that is derived from a source that is different from hemp (e.g., from a pea, a rice, or a bean).

Thus, as an example, a dough may be prepared by combining ingredients that include: hemp protein concentrate (also referred to herein as hemp protein ingredient) that contains non-hemp protein and a small amount of hemp fat; non-hemp protein ingredient (also referred to herein as non-hemp protein concentrate) that contains non-hemp protein and non-hemp fat; starch; water; and minor ingredients such as one or more of a sweetener, salt, preservative, etc.

A hemp protein ingredient (or “concentrate”) can be an ingredient that includes a major amount of protein derived from hemp, with smaller amounts of other materials that can also be derived from hemp. Example hemp protein concentrates may include at least 60, at least 70, at least 80, at least 90, or at least 95 weight percent hemp protein on a dry basis. Example hemp protein concentrates can contain less than 10, less than 8, less than 7, less than 5, or even as low as or below 3 weight percent hemp fat based on total weight of the hemp protein concentrate on a dry basis. Lower amounts of fat, if attainable, would also be useful and desirable.

As is now appreciated by the Applicant, hemp fat is a type of fat that is unsaturated (or even highly unsaturated), causing the hemp fat to be relatively unstable compared to other fats, including various fats that are derived from protein sources other than hemp. The relatively high degree of unsaturation can cause the hemp fat to be relatively unstable, e.g., prone to oxidative rancidity, when included in a finished food composition such as a puffed food composition as described herein. Applicant has surprisingly discovered that reducing an amount of hemp fat in a finished food composition, such as a puffed food composition as described, can increase the storage stability of the finished food product by reducing the total amount of unsaturated or unstable fat in the food composition and reducing the potential for oxidative rancidity.

Hemp protein concentrates are commercially available or may be prepared by commercial protein isolation techniques. Exemplary hemp protein concentrates that are currently commercially available, however, contain relatively high amounts of hemp fat, e.g., more than 14, 15, or 16 weight percent hemp fat based on total weight of a hemp protein concentrate on a dry basis. Such hemp protein concentrates are potentially unsuitable or undesirable for use according to the present description due to their high hemp fat content. Instead, hemp protein concentrates that will be more useful as an ingredient in a dough of the present description can include a lower concentration of hemp fat, e.g., not more than 10, 8, 7, 5, or even as low as or below 3 weight percent hemp fat. Similarly, because the present food compositions contain a relatively high amount of protein, hemp protein concentrates that will be particularly useful as an ingredient in a dough of the present description can include a relatively high concentration of hemp protein, e.g., greater than 70, 80, 90, or even up to or in excess of 95 weight percent hemp protein based on total weight hemp protein concentrate on a dry basis.

To provide a desired amount of non-hemp protein in a food composition, a dough composition can be prepared to include a non-hemp protein concentrate that contains a major amount of non-hemp protein, and, typically, other food materials that are also derived from the same source as the non-hemp protein, such as fat (i.e., non-hemp fat). A non-hemp protein ingredient (“concentrate”) can be an ingredient that includes a major amount of protein derived from a protein source other than hemp (i.e., non-hemp protein source), and will also normally contain a smaller total amount of other materials derived from the same non-hemp source. Example non-hemp protein concentrates may include at least 60, at least 70, at least 80, or at least 90 weight percent non-hemp protein based on total weight of the non-hemp protein ingredient, on a dry basis. Example non-hemp protein concentrates can contain less than 10, less than 8, less than 7, less than 5, or even as low as or below 3 weight percent non-hemp fat based on total weight of the non-hemp protein ingredient, on a dry basis.

Non-hemp protein concentrates are commercially available or may be prepared by commercial protein isolation techniques. Exemplary non-hemp protein concentrates that are currently commercially available may be derived from protein sources such as dairy (e.g., whey), soy, wheat, rice, fish, eggs, poultry, legume, or from another grain, vegetable, or animal source. To produce a low fat and high protein food composition as described, useful non-hemp protein concentrates can include a relatively high amount of non-hemp protein and a relatively low amount of non-hemp fat. Non-hemp protein concentrates that will be particularly useful as an ingredient in a dough of the present description can include a relatively high concentration of non-hemp protein, e.g., greater than 70, 80, or 90 weight percent non-hemp protein based on total weight hemp protein concentrate. Such concentrate can also contain a relatively low amount of fat (non-hemp fat), e.g., not more than 10, 8, 7, 5, or even as low as or below 3 weight percent fat based on the total weight of the non-hemp protein concentrate, on a dry basis. Specific examples of non-hemp protein ingredients include pea protein concentrate (PPC), pea protein isolate (PPI), rice protein concentrate (RPC), rice protein isolate (RPI), fava bean protein isolate, soy protein isolate, and sacha inchi protein isolate, any one or more of which can be included in the food composition of the present disclosure.

To provide a desired amount of starch in a dough composition, the dough composition can be prepared to include a starch ingredient that contains a major amount of starch and optional amounts of other food materials such as fat, protein, or both. Example starch ingredients can include a high concentration of one or more types of starch, e.g., at least 70, 80, 90, 95, 98, or 99 weight percent starch based on total weight starch ingredient (on a dry basis). The starch ingredient may be derived from any plant or other starch source, such as from wheat, corn, potato, rice, tapioca, oat, barley, millet, bananas, sorghum, sweet potatoes, rye, as well as other cereals, legumes, and vegetables.

Alternatively or in addition, starch may be present in a dough composition as part of a flour ingredient (or “flour” for short) that contains a combination of non-hemp protein, non-hemp starch, and non-hemp fat. The term “flour” (also, “flour ingredient”) is used herein in a manner consistent with its understood meaning in the food and baking arts, generally referring to a dry powder composition prepared by milling or grinding a flour grain such as corn, wheat, oats, etc., with the ground or milled powder composition containing protein and starch from the original flour grain in relative amounts that are comparable to the amounts of starch and protein in the original flour grain. According to example dough compositions of the present description, a flour ingredient is not required, and a flour ingredient may be excluded from certain example dough compositions of the present description or used in not more than a low or insignificant amount, such as below 3, below 2, or below 1 weight percent flour per total weight dough on a dry basis.

In addition to ingredients of a dough that include hemp protein concentrate, non-hemp protein concentrate, and a starch ingredient, a dough may contain minor amounts of other ingredients as desired for preparing a finished (puffed, dried) food composition. Minor food materials or ingredients that may be included in the composition may include flour (see above), sugar (e.g. fructose, sucrose, glucose, etc.) or another natural or synthetic sweetener, salt, another flavorant, fiber, various vitamins and minerals, a preservative, an antioxidant, or a pH adjuster or buffer, any of which may be added alone or as part of another ingredient of a dough composition.

According to certain embodiments, the food composition can contain relatively low amounts of gluten or may be considered to be “gluten-free,” e.g., can contain no concentrated gluten ingredient and no gluten-containing ingredients, e.g., may contain less than 1 percent, e.g., less than 0.5 or less than 0.3 weight percent total gluten based on total weight of the food composition on a dry basis.

In some embodiments, the food composition optionally comprises an antioxidant. The antioxidant can comprise a tocopherol or a mixture of tocopherols, including one or more of alpha-tocopherol, beta-tocopherol, gamma-tocopherol, or delta-tocopherol. Although various tocopherols have been described, skilled artisans will appreciate that any food-safe antioxidant can be used. The antioxidant is present in the food composition in a low amount, such as less than 1 weight percent, less than 0.5 weight percent, or even less than 0.2 weight percent based on total weight of the food composition on a dry basis.

According to this disclosure, a food product is prepared to include hemp protein in an amount that provides useful, desired, or improved processing, flavor, physical properties (e.g., density), or sensory or textural properties. An exemplary composition in the form of a finished puffed food composition can exhibit one or more improved properties of texture, sensory properties, taste, or a reduced density compared to a comparable food product, which is a food product made of the same types of food materials or ingredients, including the same total amount of protein, starch, and fat, but without the hemp protein and hemp fat. An example comparable food product can be made with the same amounts of total fat and protein but does not include a hemp protein concentrate.

Puffed food compositions (also referred to as “expanded” food compositions or “low density” food compositions) are popular among consumers because of their convenience and because of their appetizing flavor and textural properties, including crunch.

To prepare an expanded food composition as described, ingredients of the food product are first combined to form a dough with an amount of water that is useful for processing the dough by expansion. The dough is then processed to form a finished, e.g., puffed and dried, food composition.

To form the dough, ingredients that contain desired food materials are combined with water to make a dough that can be processed by expansion into a food product. The dough can include solid materials in amounts as described, that will be useful to form the dough first into an extruded food composition (extrudate), and then into a dried, finished puffed food composition having desired mechanical, textural, and organoleptic properties.

A puffed food product as described can be in the form of an individually formed food piece that includes a solid and dried matrix (which may include some amount of water) that defines numerous openings or “cells” (air pockets or open spaces) interspersed between walls that form a matrix that defines the cells, giving the expanded food piece a high porosity and reduced density. The matrix is made of the expanded and typically dried dough. In certain embodiments, the dried food piece is “self-supporting,” meaning that each piece is sufficiently dry and rigid to support its own weight. Examples of commercial expanded, low density snack or cereal products include those available as Baked Cheetos®, Puffed Cheetos®, and similar expanded corn-based cheesy snack foods, as well as Kix® and Cheerios® brand breakfast cereals.

A puffed food composition has a water content that is sufficiently low to exhibit crisp or frangible mechanical properties and to be self-supporting. Water can be present in a dried puffed food composition in any useful amount, with exemplary amounts of water being below about 5 weight percent, e.g., from about 1 to about 4 weight percent, based on the total weight of the dried food product or piece. The amount of water may vary depending on the desired composition and physical properties of the dried food composition.

A puffed food product that contains hemp protein as described may be produced by any known or developed method of preparing a water-containing dough, and processing the dough at elevated temperature, pressure, and shear by use of an extruder, or that is “gun puffed,” fried, directly expanded, or otherwise caused to expand to a reduced density during processing. An amount of volatilizable agent such as water or other plasticizing agent (e.g., a polyhydric alcohol such as glycerol or the like) can be included in the dough in an amount to allow the dough to flow under pressure through an extruder as a dough composition, followed by extrusion and expansion of the dough at the extruder opening (e.g., die). The amount of water in a dough may be any amount that is useful to allow for processing by expansion. Example amounts may be from about 13 to about 30 weight percent water based on total weight of the dough (water and solids), but other amounts may also be useful.

In an extrusion method, an extruder passes a dough under pressure and at an elevated temperature through a die or other opening. Volatilizable agent, generally the water component of the dough, alternately steam, can become depressurized upon the dough exiting the extruder, causing the volatilizable agent to expand, which in turn causes the dough to expand and form a cell-containing structural matrix typical of a puffed food composition of the present description.

For extrusion methods, any suitable food extruder can be used, such as a single or twin screw extruder. The extruder heats the dough to a temperature sufficient to allow for desired flow, with exemplary operating ranges being at least about 95 degrees Fahrenheit. The pressure in the extruder can be any pressure useful to allow the dough to flow through the extruder and through the extruder opening to produce a desired extruded and expanded food product; examples of useful pressures may be at least about 200 or 400 pounds per square inch, up to about 700 or 800 pounds per square inch. The heated and pressurized dough can be forced through an extruder opening, upon which the heated water in the dough forms steam due to the pressure reduction upon exiting the extruder, resulting in an expansion or puffing of the extruded dough. The volumetric expansion at the extruder opening may be as desired, for example expansion by an amount of at least 2 times the size of the extruder opening. Also upon this expansion, the expanded dough may be cut, formed, or shaped, e.g., molded, into a desired shape and desired dimensions.

The product after extrusion, expansion, and optional cutting and shaping into an expanded dough piece can be dried by any known method to reduce water content. Before or after drying, the extruded food pieces may be processed by application of a coating, if desired, such as a flavor coating. The coating can be applied by any useful method such as by spraying, tumbling, or any other suitable application technique.

The following table provides of examples of various food compositions, two of which are in accordance with the present food composition (both Low Fat Hemp Pea Crisps) and two of which are comparative examples (High Fat Hemp Pea Crisp and Low-Fat Pea Crisp). As can be seen from this table, the food compositions described in the present application provide a lower density food product as compared to both a low-fat pea crisp and a high-fat hemp protein concentrate (High Fat Hemp Pea Crisp).

### Examples

| | High Fat Hemp | Low-fat | Low Fat Hemp | Low Fat Hemp |
|---|---|---|---|---|
| | Pea Crisp | Pea Crisp | Pea Crisp | Pea Crisp |
| Factor 1 - Target Protein | 60% | 60% | 60% | 60% |
| Level | | | | |
| Factor 2 - Target Protein | 30:70 | 0:100 | 20:80 | 30:70 |
| Ratio (Hemp:Pea) | | | | |
| Organic Ingredients | | | | |
| Hemp Protein | | 0.00 | 16.16 | 31.56 |
| Concentrate; 3.8% fat | | | | |
| Hemp Protein | 29.40 | | | |
| Concentrate; 16.0% fat | | | | |
| Pea Protein Concentrate | 44.10 | 75.00 | 62.74 | 47.34 |
| (80%)-Vegotein P80 | | | | |
| (2008502) | | | | |
| Organic Tapioca Starch | 39.58 | 25.00 | 21.10 | 20.95 |
| Total | | 100.00 | 100.00 | 99.85 |
| Total Protein (%)-As is | 57.4 | 61.9 | 63.1 | 61.2 |
| Hemp % of Total Protein | 34% | 0% | 17% | 34% |
| % Fat in Formula | 8.6% | 6.7% | 6.1% | 5.2% |
| % Moisture | 1.23% | 3.4% | 2.0% | 1.7% |
| % Solids | 98.8% | 96.6% | 98.0% | 98.4% |
| Finished Density (g/cc) | 0.40 | 0.30 | 0.21 | 0.21 |

| | | |
|---|---|---|
| % reduction in density vs. low-fat pea crisp | 31.3% | 30.3% |
| % reduction in density vs. high fat hemp protein concentrate | 48.2% | 47.4% |

What is claimed is:

1. A food composition comprising:
starch,
at least 40 weight percent protein, the protein comprising hemp protein and non-hemp protein, and
less than 10 weight percent total fat,
wherein the weight percentages of protein and total fat are based on total weight of the food composition on a dry basis.

2. The food composition of claim 1 wherein the food composition is an extruded food composition having a density that is lower than a density of a comparable food composition, the comparable food composition having a same weight percentage of total protein as the food composition but being devoid of hemp protein.

3. The food composition of claim 1 comprising:
from 5 to 40 weight percent starch,
from 40 to 80 weight percent total protein, and
from 1 to 5 weight percent total fat,
based on the total weight of the food composition on a dry basis.

4. The food composition of claim 1 comprising:
from 0 to 7 weight percent non-hemp fat, and
from 0.1 to 5 weight percent hemp fat,
based on the total weight of the food composition on a dry basis.

5. The food composition of claim 1 wherein the hemp protein is part of a hemp protein ingredient, the hemp protein ingredient comprising at least 70 weight percent hemp protein and not more than 10 weight percent hemp fat, based on total weight of the hemp protein ingredient on a dry basis.

6. The food composition of claim 1 wherein the hemp protein is part of a hemp protein ingredient, wherein the hemp protein ingredient comprises:
from 60 to 95 weight percent hemp protein,
less than 6 weight percent fat, and
less than 10 weight percent water,
based on total weight of the hemp protein ingredient on a dry basis.

7. The food composition of claim 1 wherein the non-hemp protein is part of a non-hemp protein ingredient, the non-hemp protein ingredient comprising at least 60 weight percent non-hemp protein and not more than 10 weight percent non-hemp fat, based on total weight of the non-hemp protein ingredient on a dry basis.

8. The food composition of claim 1 wherein the non-hemp protein comprises at least one of soy protein, pea protein, rice protein, legume protein, sacha inchi protein, algal protein, and mycoprotein.

9. The food composition of claim 8 wherein the non-hemp protein comprises pea protein.

10. The food composition of claim 1 wherein the food composition is a puffed food composition having a water content below 5 weight percent based on the total weight of the food composition.

11. The food composition of claim 1 wherein the food composition is an extruded food composition having a density that is below 0.3 grams per cubic centimeter.

12. The food composition of claim 1 wherein the food composition is an extruded food composition having a density that is below 0.25 grams per cubic centimeter.

13. The food composition of claim 1 wherein the food composition contains less than 1 weight percent total gluten based on the total weight of the food composition on a dry basis.

14. A method of preparing an expanded food composition, the method comprising:
combining ingredients to prepare a dough that comprises:
starch;
at least 40 weight percent protein on a dry basis, the protein comprising hemp protein and non-hemp protein; and
less than 10 weight percent total fat on a dry basis; and
extruding the dough to form an expanded food composition.

15. The method of claim 14 further comprising drying the expanded food composition.

16. The method of claim 15 wherein, after drying, the expanded food composition has a water content below 5 weight percent based on total weight of the expanded food composition.

17. The method of claim 14 wherein the expanded food composition has a density that is below 0.3 grams per cubic centimeter.

18. The method of claim 14 wherein the hemp protein is part of a hemp protein ingredient, the hemp protein ingredient comprising at least 70 weight percent hemp protein and not more than 10 weight percent hemp fat, based on total weight of the hemp protein ingredient on a dry basis.

19. The method of claim 14 wherein the hemp protein is part of a hemp protein ingredient, wherein the hemp protein ingredient comprises:
from 60 to 95 weight percent hemp protein,
less than 6 weight percent fat, and
less than 10 weight percent water,
based on total weight of the hemp protein ingredient on a dry basis.

20. The method of claim 14 wherein the non-hemp protein comprises at least one of pea protein, rice protein, and legume protein.
